(19) United States
(12) Patent Application Publication
(10) Pub. No.: US 2010/0309287 A1
(43) Pub. Date: Dec. 9, 2010

(54) 3D Data Representation, Conveyance, and Use

(76) Inventor: Tony F. Rodriguez, Portland, OR (US)

Correspondence Address: DIGIMARC CORPORATION, 9405 SW GEMINI DRIVE, BEAVERTON, OR, 97008, US

(21) Appl. No.: 12/727,092

(22) Filed: Mar. 18, 2010

Related U.S. Application Data
(60) Provisional application No. 61/162,201, filed on Mar. 20, 2009.

(51) Int. Cl. H04N 13/00

(52) U.S. Cl. 348/43; 348/E13.001

(57) ABSTRACT

3D video can be transmitted in a legacy 2D video format by conveying 3^{rd} dimension parameters within a steganographic channel of the perceptual video signal, e.g., DCT coefficients, video samples (luminance, chrominance values), etc. The 3^{rd} dimension parameters can be coded as depth values, disparity, displacement, difference, or parallax values, including depth that is converted into X-Y shifts for adjustment to motion vectors in coded video sequence. To limit the amount of information for the steganographic channel, the 3^{rd} dimension information can be quantized relative to the depth from viewer and other prioritization parameters that limit the need for 3^{rd} dimension information to only aspects of the scene that are deemed important to create a desired 3D effect.

### RELATED APPLICATION DATA

This application claims the priority to provisional application 61/162,201, filed Mar. 20, 2009, which is incorporated herein by reference.

### TECHNICAL FIELD

The present disclosure relates to stereoscopy and 3D video, and to related creation, transmission and rendering of 3D video.

### INTRODUCTION

A key challenge raised in migrating 3D video (and to a lesser extent still imagery) out of the Digital Cinema and into the digital living room, is the need to be backwards compatible with existing transport mechanism, protocols and displays. Put another way, requiring build-out of new distribution channels (infrastructure at cable operators, set-top boxes, DVR's. etc.) to deliver 3D content for the home is problematic, especially if it is not backwards compatible with existing displays and devices. It is the conversion from black & white (BW) to color transmission all over again, except that this time there is much more infrastructure at play, as the distributions paths are varied (satellite, cables, IPTV, etc.) and the devices are more diverse in functionality.

Analogous to the BW to color changeover, a mechanism is needed to create rich 3D experiences in the home, utilizing existing protocols (MPEG2, VC-1, H.264, etc.) on the emerging display technology, yet guarantee that if the same HDMI cable were plugged into a 2D only display, the experience would be identical to a traditional 2D broadcast. This even holds true for analog video distribution systems, which are still the majority of the installed base.

In stereoscopy, the illusion of depth is created by providing separate, but highly correlated, images for each eye. Placing different objects on the Z-axis is accomplished by shifting those pixels in the horizontal and vertical coordinate positions (X, Y) associated with an object more, or less, to create a sense of depth. The larger the displacement in X, Y, the closer the object appears, and vice versa.

Regardless of the commercially deployed techniques (anaglyph images with colored lenses, polarized imagery with polarized, shutter glasses, etc.) used in the theater or at home (autostereoscopic displays, such as displays with a parallax barrier, lenticular lenses, etc.), they all rely on this approach.

Depth within the scene can then be imbued to an object by shifting the corresponding pixels by a predetermined amount and creating a secondary image, resulting in two images, one for each eye.

There are a variety of ways to capture stereo video. One approach is to capture video using two or more cameras, such as a stereo camera pair to capture left and right images corresponding to left and right eye viewing perspectives. Stereo matching and correspondences methods can be used to derive depth and disparity information from corresponding pairs of images from these cameras. Another approach is to use depth-range camera technology, which generates a sequence of color images and corresponding per-pixel depth image of a scene. This color and depth information is used to generate two virtual views for the left and right eye using a Depth-Based Rendering (DIBR) method. The following equation is used to generate the two virtual views:

$${P}_{pix} = - {x}_{B} \frac{{N}_{pix}}{D} [ \frac{m}{255} ( {k}_{near} + {k}_{far} ) - {k}_{far} ]$$

A research project called Advanced Three-Dimensional Television System Technologies (ATTEST) was conducted to study a 3D-TV broadcast chain. This project began to address backward compatibility issues by exploring delivery of content over a 2D digital TV broadcast infrastructure. In particular, this project targeted the use of MPEG-2 broadcast standards to transmit monoscopic color video in a format compatible with existing 2D-TV set top boxes and newer coding formats to transmit depth information from which 3D video could be rendered using DIBR methods at the receiver. In this approach, the depth information is represented as per-pixel depth images, which are compressed separately from the color video information and transmitted in an enhancement layer.

Some examples of schemes that follow this general approach for coding 3D video include the following. 3DAV, an ad hoc group of MPEG has identified MPEG-4 MAC (Multiple Auxiliary Component) for encoding color and depth stereoscopic video content. MPEG-4 MAC allows the encoding of auxiliary components in addition to YUV components of 2D video. The depth/disparity information can be coded into one of the auxiliary components. Another approach is to combine the color and depth images into a single video stream to serve as input to the H.264/AVC codec, such as side by side color-depth images or interlaced color-depth images. Another approach is to code the color and depth/disparity image sequences as base and enhancement layers, e.g., using H.264/SVC video coding format.

Video coding standards bodies that are investigating 3D video coding formats include MPEG-C, part 3; multi-view coding (MVC), and 3D video coding initiative (3DVC). ISO/IEC 23002-3 Auxiliary Video Data Representations (MPEG-C part 3) is meant for applications where additional data needs to be efficiently attached to the individual pixels of a regular video. 3D video is represented in the format of single view and associated depth, where the single channel video is augmented by the per-pixel depth included in the bitstream as auxiliary data. Rendering of virtual views is left for the receiver side. Multiview Video Coding (MVC, ISO/IEC 14496-10:2008 Amendment 1) is an extension of the Advanced Video Coding (AVC) standard. It targets coding of video captured by multiple cameras. The video representation format is based on N views, i.e. N temporally synchronized video streams are input to the encoder which outputs one bitstream to be decoded and spit into N video signals at the decoder. As a standard, 3DVC targets serving various multi-view displays. N output display views are assumed. However, a lower number of K views is assumed to be coded and transmitted. To enhance the rendering capabilities, the transmitted views are augmented with additional depth information coded in depth channels. The number of views and depth channels is an open research question. This representation generalizes the possibilities of MPEG-C, Part 3 and MVC. ISO/IEC FCD 23000-11 is a new MPEG application format standard named Stereoscopic Video Application Format. This format purports to be aimed at providing an interoperable storage format for stereoscopic video and associated audio, images, and metadata.

Various conveyance arrangements for 3^{rd} dimension data have been proposed, including auxiliary data channels in the MPEG data stream, and vertical blanking interval transmission. A few writers have proposed digital watermarking schemes (e.g., patent publication US20040101043, and Lee, “Stereo Sequence Transmission via Conventional Transmission Channel,” SPIE Vol. 5022, pp. 792,799). However, these proposed techniques suffer a variety of drawbacks.

In certain aspects, the presently-detailed technology seeks to overcome drawbacks of the prior art, and provide performance advantages not previously contemplated.

In one respect, this disclosure describes methods and systems for coding 3^{rd} dimension parameters and inserting them into a steganographic channel within active components of the video. This disclosure also provides new formatting methods for the 3^{rd} dimension information that can be used with or without steganographic encoding. The disclosure describes complementary methods and systems implemented at the video receiver for extracting and generating 3D video from a 2D video signal, as well as decoding 3^{rd} dimension information and rendering 3D video with it.

In accordance with one aspect of the present technology, 3D video is transmitted in a legacy 2D video format by conveying 3rd dimension parameters within a steganographic channel of the perceptual video signal, e.g., DCT coefficients, video samples (luminance, chrominance values). The 3rd dimension parameters can be coded as depth values, disparity or parallax values, including depth that is converted into X-Y shifts for adjustment to motion vectors in coded video sequence. To limit the amount of information for the steganographic channel, the 3rd dimension information may be quantized relative to the depth from viewer and other prioritization parameters that limit the need for 3rd dimension information to only aspects of the scene that are deemed important to create a desired 3D effect.

In accordance with another aspect of the present technology, 3D video is encoded at a source and distributed to plural different viewing systems. The encoded 3^{rd} dimension data does not define any one particular rendering experience, but rather enables different viewing systems to render the video with different 3D video effects. That is, one viewing system can interpret the 3^{rd} dimension data to yield one effect (e.g., shallower 3D), and another viewing system can interpret this same data to yield a different effect (e.g., exaggerated 3D). A control at the video rendering system, which may be user-settable, determines how the 3^{rd} dimension data is applied. Thus, a common video stream supports many different viewing environments.

Further features will become apparent with reference to the following detailed description and accompanying drawings.

### BRIEF DESCRIPTION OF THE DRAWINGS

FIG. 1 is a system diagram illustrating the workflow of 3D video creation and formatting for distribution in a 2D video channel.

FIG. 2 is a system diagram illustrating system components of an end-user's system for receiving a 2D video channel, extracting 3D video information and displaying 3D video.

FIG. 3 is a flow diagram illustrating a process for preparing 3D video for distribution in a 2D video channel.

FIG. 4 is a flow diagram illustrating a process for receiving a 2D video input and constructing 3D video for display.

FIG. 5 is a diagram illustrating a steganographic encoder for inserting 3D information in a primary 2D video signal compatible with legacy delivery, rendering and display equipment.

FIG. 6 is a diagram illustrating a steganographic decoder for extracting 3D information from a primary 2D video signal.

### DETAILED DESCRIPTION

The following sections describe examples of workflows and systems for creating, coding, transmitting and rendering 3D video. The term 3D video is not intended to be limiting, but instead, is intended to encompass formats for representing image content on a video output device that gives the viewer the perception of three dimensional objects. These include formats for representing stereoscopic video, omni-directional (panoramic) video, interactive, multiple view video (free viewpoint video) and interactive stereo video. These formats also include 3D still imagery, including stereoscopic still images. In addition to the horizontal (X) and vertical (Y) locations corresponding to image sample locations for the 2D display, 3D video equipment used with a 2D display depicts a third dimension, called depth (or disparity), typically represented by the variable, Z. Humans perceive a 3D effect because each eye views the world from a different perspective. Likewise, in the field of stereoscopy and 3D imagery on 2D displays, the viewer perceives a 3D effect by creating a disparity between what each eye sees, e.g., left and right pictures of a scene for the left and right eyes. To simplify the terminology, the following discussion uses the term “3D video” to embody this range of concepts, taking into account that parameters of depth, disparity, displacement, difference, and parallax are different terms, yet addressing a similar concept of a parameter that encodes information about a third dimension. To encompass these concepts in one term, we use the term, 3^{rd} dimension parameter. Further, while video is primarily discussed, the principles apply to processing 3D still imagery as well.

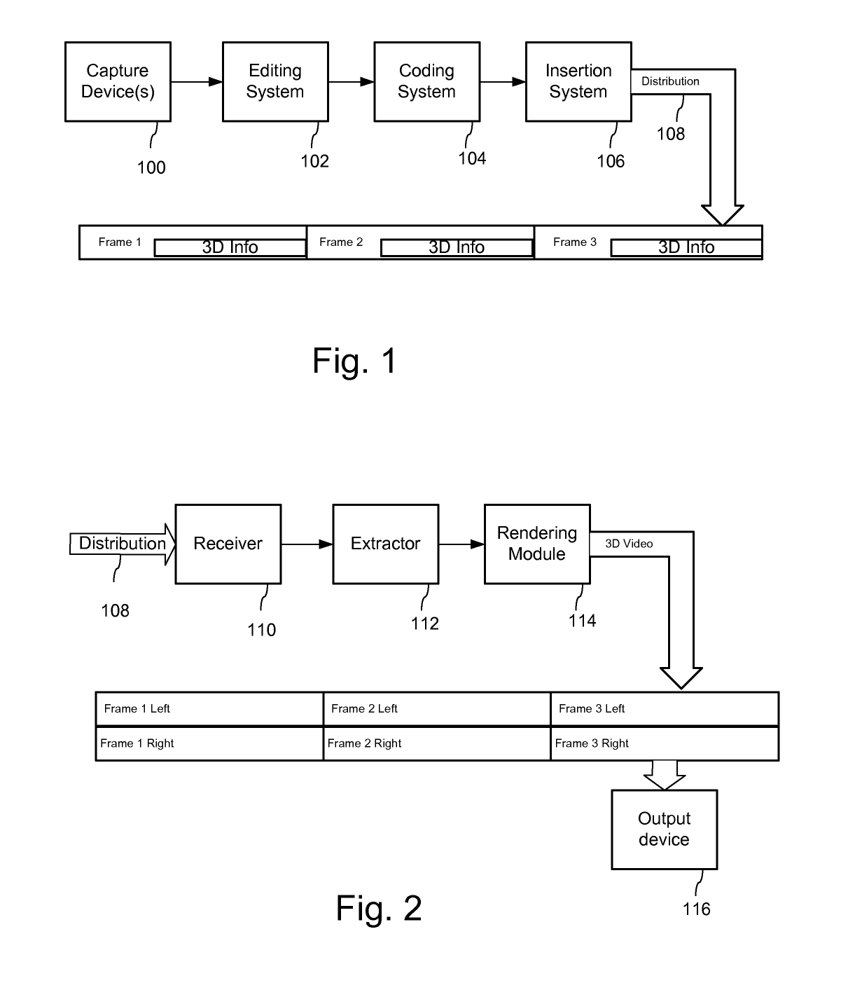

FIG. 1 is a system diagram illustrating the workflow of 3D video creation and formatting for distribution in a 2D video channel. The first point in the workflow is a capture device or devices 100 that captures video of a scene from different camera locations. Of course, the video from different perspectives can also be generated from 3D models and other techniques that simulate the 3D effect, e.g., by projecting an image from a 3D scene into images at different viewing locations. The result is at least one sequence of video (e.g., left and right video sequences) and optionally other parameters used to generate images at desired viewing locations, such as depth, disparity or parallax parameters used to generate two or more 2D video sequences for 3D viewing equipment. These 3^{rd} dimension video parameters may include depth, disparity, displacement, difference, or parallax values mapped to pixel locations/regions, geometric transformation parameters (e.g., for projecting an image or model into an image at a desired perspective), opacity (e.g., to represent the extent to which background objects are visible through foreground objects), occlusion (priority/location of objects in a scene to enable calculation of which objects are visible from a particular viewing location), etc.

In the editing system 102, this raw 3D video information is edited to create the desired 3D video sequence. This may include combining video sequences from different cameras, camera location data and related viewing location data, into one or more video sequences along with parameters to generate video sequences at different perspectives at the receiver. The editing system typically includes a manual input process where the editor selects the video sequences and associated audio track and 3D parameters to enable rendering of the video to create desired 3D effects as well as enable viewing in a traditional 2D video mode. This type of manual input process enables creative input that creates the emotional impact desired by the creative artist (e.g., film director), such as using colors or color filters, lighting, shadowing, contrast, texture mapping, etc. to give a desired warmth or other emotional impact to objects in a scene, and emphasis of 3^{rd} dimension information that further enhances this emotional impact by exaggerating relative depth of foreground vs. background objects, etc. The editing system also includes automated tools that perform tasks like stereo matching and correspondence, opacity, depth and disparity calculations, and automated color and depth transformations to create special effects with the desired emotional impact on the viewer, etc. Ultimately, the editing system produces the primary video sequence, its audio track (including supplementary tracks and surround sound information), and additional 3D video information to enable rendering for 3D on 3D viewing equipment.

The coding system 104 performs two primary functions. First, it formats the primary video signal in a standard 2D video format (such as video compression format commonly used for satellite, cable, Internet Protocol, or terrestrial broadcast/delivery like MPEG2, H.264, Adobe Flash, etc.). Second, it formats the 3D components for this primary video signal. The formatting depends on the type of 3D video rendering environment expected to be in place at the receiver. The formatting may be made specific to a particular display format, or it may be more generalized to enable the receiver to adapt the 3D information for different display formats present in the receiver, such as formats that take advantage of DIBR methods at the receiver. Stated another way, the task of device specific rendering of 3D video can be split between the video editor/coder on the one hand, and the receiver, on the other. If the receiver has greater rendering capability, the coder need only include high level depth and scene information from which the rendering device generates the display specific 3D video information. This approach provides display independence, at the cost of requiring more rendering capability at the receiver. If the receiver has limited rendering capability, the editor/coder must supply the 3D video information that requires less transformation (and thus simpler computation) at the rendering device. In this case, device independence might still be supported to some extent, but multiple different display format support may need to be encoded in the video distribution/transmission channel.

The insertion system 106 embeds the 3D components in the primary video signal. This is a process in which the active video/audio data in the legacy 2D video format like MPEG-2 are modified to convey the 3D components as well as the primary video signal. Example embodiments of insertion systems are described further below.

After insertion, the coded 3D video is transmitted through a legacy 2D video transmission channel or 3D video channel (108). One advantage of the coding and insertion scheme is that it does not require additional metadata in the compressed video stream to carry 3D video information or signal its presence. Thus, while it is possible to include 3D information in additional layers or auxiliary streams as have been proposed, the insertion of 3D information in the primary video channel obviates the need for such schemes.

FIG. 2 is a system diagram illustrating system components of an end-user's system for receiving a 2D video channel, extracting 3D video information and displaying 3D video. At a receiver 110, the coded video data is decoded using the video coding standard compatible with the coding scheme used in the transmission system. The 3D video information is extracted from the parsed and partially decoded compressed bitstream in the extractor 112. Rendering module 114 in the receiver constructs 3D video information from the primary 2D video channel and 3D information in a manner that is compatible with the display technology. Finally, this rendered video is output on output device 116.

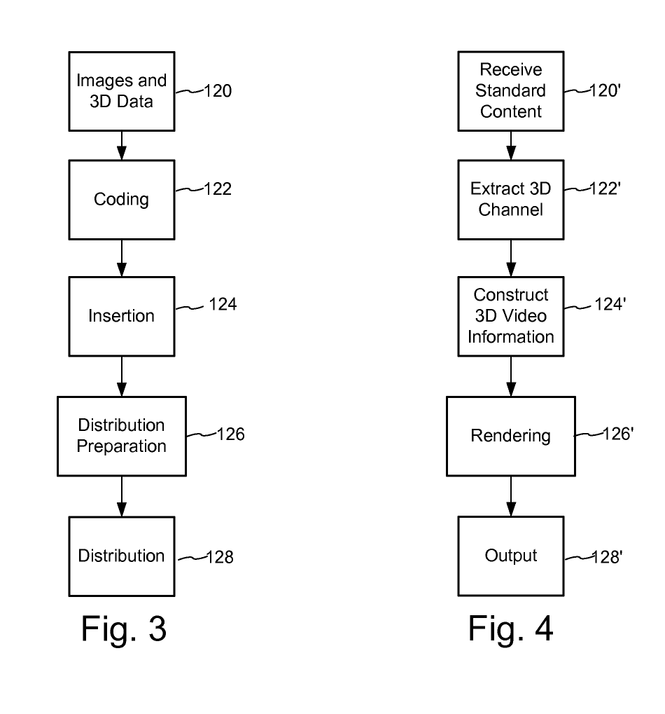

FIG. 3 is a flow diagram illustrating a process for preparing 3D video for distribution in a 2D video channel. The images and related 3D information from the editing process (120) are input to a coding process 122 that compresses the primary video signal using a 2D compression codec and compresses the 3D information. The insertion process 124 inserts the compressed 3D information into coded or partially coded elements (e.g., quantized DCT coefficients from the quantizer or partially decoded coefficients from a compressed signal) of the primary video signal and completes the coding or re-coding of the video stream according to the 2D compression codec. While illustrated as a separate process, the insertion process can be and in many cases is preferably integrated into the coding process so that compression steps used in video and 3D information can be combined where appropriate. The distribution preparation process 126 finalizes the formatting of the video for transmission by the distribution process 128, which can include terrestrial over the air broadcast, cable transmission, IPTV, satellite or other content distribution and delivery infrastructures.

FIG. 4 is a flow diagram illustrating a process for receiving a 2D video input and constructing 3D video for display. The process begins when a receiver device receives video content as shown in block 120. In legacy equipment, the video content appears to be standard video content, and the equipment displays it as normal. In equipment that includes 3D video support, the receiving device captures the standard 2D video stream, partially decodes it to extract the portion of the video data that has been modified to include 3D information, and proceeds to extract the 3D channel as shown in block 122. The process of extracting the 3D information is compatible with the steganographic embedder used to insert this information prior to distribution. Shown as block 124 in FIG. 4, this process includes decoding operations like error correction. The receiver then executes a process of constructing the 3D information, which may include decompression of the 3D information, as well as transformations of the decompressed information to place it a form where it can be used to render a 3D video sequence or sequences from viewing perspectives that differ from the primary 2D video signal. Examples of these types of transformations include interpolation and mapping of depth values or color modifications (e.g., for video to be viewed with 3D glasses) to pixel locations for a particular video output display format.

A rendering process, shown in block 126, uses the 3D video information to generate video streams particular to the 3D video equipment at the viewing location. This includes transforming video signals from the primary video channel to create modified video or video sequences. For DIBR formatted video, the rendering process includes using the primary video and depth information to create 3D video. For anaglyph formats, the rendering process includes using the 3D information to compute color modifications. Finally the 3D video is transmitted to the output device (128) for display.

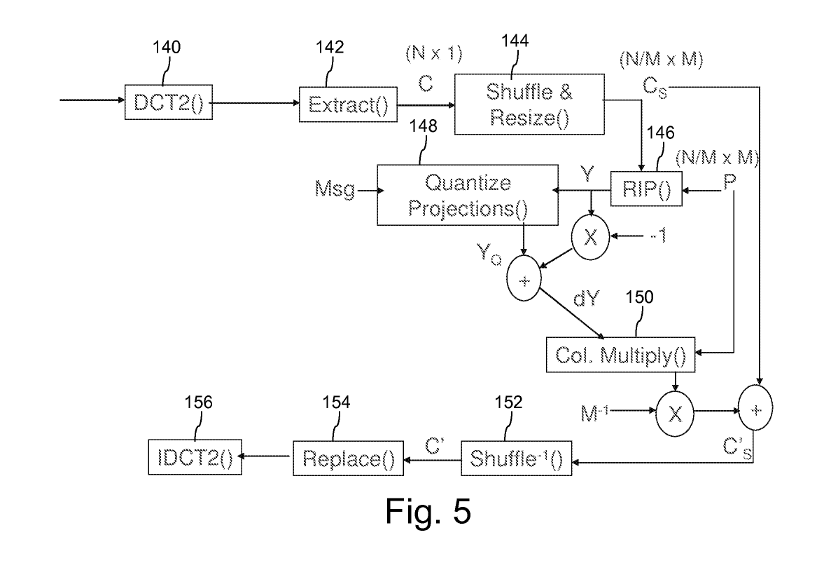

FIG. 5 is a diagram illustrating a steganographic encoder for inserting 3D information in a primary 2D video signal compatible with legacy delivery, rendering and display equipment. In the upper left region of the figure, the primary video signal is input to block 140 labeled “8×8 DCT2( ),” where the video image frame is partitioned into non-overlapping 8×8 blocks, and the two-dimensional forward discrete cosine transform (DCT) is applied to each. This DCT transformation is common to video coding standards like MPEG-2 and MPEG-4 and H.264, thus, the steganographic encoder can be integrated with video compression coders that partition video images and compute the DCT transform.

Block 142 labeled “Extract( )” takes the lowest 12 AC coefficients in zig-zag order from each block and places them in an Nx1 buffer labeled “C.” Block 144 labeled “Shuffle and Resize( )” rearranges the coefficients using a pseudo-random mapping function to yield an N/M×M array, Cs. Hence, each row of M coefficients has representation from diverse sections of the image.

The heart of the embedder resides in the group of operations beginning with block 146 labeled RIP (Row-wise Inner Products) and leading to Cs', the set of embedded coefficients. The RIP block takes the arrays Cs and P (a pseudo-random array with elements {1,1} also of size N/M×M) as input. The output, Y, is the dot product of each row of Cs with the corresponding row of P. Said another way, each component of the N/M x 1 array, Y, is the projection of each row of Cs onto each row of P. The projections are quantized using one of two quantizers 148 for each message bit. For more information on quantization based steganographic embedding, see: U.S. Pat. No. 7,376,242, which is incorporated by reference in its entirety.

In order to generate Cs', the set of embedded coefficients, the original projections are subtracted from the quantized projections, and the result of each difference is evenly distributed through the M coefficients that comprise each row of Cs. Mathematically, this is given by the following equation for the kth row of Cs, where we see that the projection modulates the differences.

Cs′(k)=Cs+(Yq−Y)/M*P(k)

As shown in FIG. 5, the differences between the quantized and original projections are divided by M and multiplied by the pseudorandom array P(k) in block 150. The watermarked video image is created from the set of embedded coefficients, Cs, by de-interleaving the coefficients in block 152 labeled “Shuffle-1( )′, replacing the original lowest 12 AC coefficients of every block with the embedded versions, and finally performing inverse 8×8 DCTs in block 154 (though this is not required where the steganographic embedder is integrated into the video compression coder.

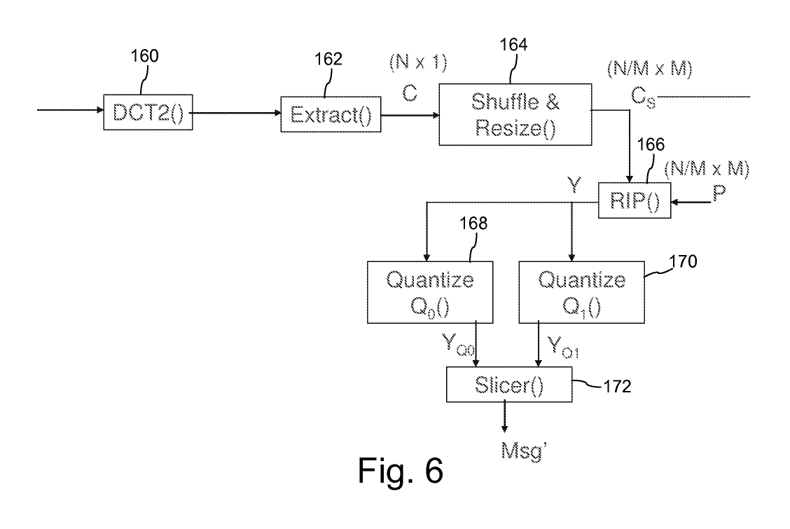

FIG. 6 is a diagram illustrating a steganographic decoder for extracting 3D information from a primary 2D video signal. The steganographic decoder's operations beginning with the forward DCTs and ending with the set of projections onto the pseudo-random vectors, P, are a repeat of the corresponding steps in the embedder of FIG. 5 (blocks 160-166 correspond to blocks140-146). Given each projection in turn, an estimate of the embedded message bit is obtained by determining which quantizer (e.g., quantizer 168 or 170) contains a centroid that is closer to the projection than all other centroids. This process is implemented by first using both quantizers to quantize the projection. The “Slicer( )” block 172 is responsible for choosing the quantizer that has the smaller quantization error and outputting the corresponding bit. One quantizer is labeled ‘1 ’ and the other is labeled ‘0 ’. For example, if a projection is closest to a centroid in the ‘1 ’ quantizer, a ‘1 ’ bit is output.

In one embodiment, the steganographic encoder and decoder of FIGS. 5-6 are used to insert depth information into the primary video signal as the message. The above quantization method has the ability to carry upwards of 20,000 bits in a VGA sized I frame of an MPEG2 stream at 5 mb/s. Greater capacity can be achieved by using more coefficients than the 12 per block, mapping each message symbol to fewer coefficients (less redundancy of the message), and/or using forms of vector quantization that encode more message symbols per block. This provides sufficient coding space to carry depth or disparity information based on the following optimizations/observations.

### Depth Perception

To compress a depth map prior to embedding, one embodiment coarsely quantizes the 3^{rd} dimension parameter by quantizing the depth values, where the quantization is scaled non-linearly along the Z-axis. The depth information is compressed by exploiting the fact that certain X-Y regions of the scene require more depth detail, while other portions require less or none.

To compress a depth map for DIBR techniques prior to embedding, the depth is coarsely quantized by quantizing the depth values, where the quantization is scaled non-linearly along the Z-axis and along vectors emanating from the vanishing point of the frame. This takes the form of an inverse logarithmic sampling (more coarse the further the depth) along a spherical coordinate system anchored at the vanishing point of the frame.

A further enhancement or alternative is to be content specific, relying on image segmentation techniques, manual or otherwise, to prioritize depth information for specific objects within the frame. Segmentation separates image frames into specific objects, and this can be done with automated image segmentation analysis (morphological segmentation, for example), blue screen image capture techniques, and compositing of video features shot in separate scenes and then combined. By prioritizing depth information for sub parts of a frame for the most important objects in that frame, the amount of depth information is reduced per frame. And as such, this prioritized depth information can be compressed in such a manner so as to be transmitted using a variety of digital watermarking algorithms.

As an example, anchored in a Cartesian coordinate system for purposes of illustration, the Z axis could be quantized into 10 levels of depth, each becoming progressively more coarse in X,Y as the vanishing point is approached. Based on a HD frame (1920×1080) and a minimum feature size of 2×2 pixels at the 0th level of depth (front of stage), 832 bits are required to encode the depth frame.

A table outlining an example of the data requirements for depth information quantized into levels of depth is presented below. As distance from the viewer increases along the Z axis, the number of depth locations per level decreases:

| Level | | | Depth | | |
|---|---|---|---|---|---|
| Of | X DIM | Y DIM | Location | | |
| Depth | 1920 | 1080 | per Level | Total bits needed | |
| 2 × 2 | 960 | 540 | 518,400.00 | 832.00 | 692,224.00 |
| 4 × 4 | 480 | 270 | 129,600.00 | | |
| 8 × 8 | 240 | 135 | 32,400.00 | | |
| . | 120 | 67.5 | 8,100.00 | | |
| . | 60 | 33.75 | 2,025.00 | | |
| . | 30 | 16.875 | 506.25 | | |
| . | 15 | 8.4375 | 126.56 | | |
| . | 7.5 | 4.21875 | 31.64 | | |
| . | 3.75 | 2.109375 | 7.91 | | |

| | |
|---|---|
| 691,197.36 | total number of |
| | “depth” locations |

It is recognized that content independent modeling of required size of depth information as described above is an approximating tool. Ideally, depth information would be object specific and hence the number of objects would dictate the number of bits needed to convey depth.

Another approach is to leverage existing segmentation information provided by the presence of motion vectors for groupings of pixels for use in predictive frames in codecs such as MPEG2. The motion vectors not only identify blocks, aiding in segmentation, but perception of depth can be imparted by providing left and right eye displacements for each motion vector. This has a coding benefit of only needing to transmit the X,Y displacements of pre-existing motion vectors as the 3^{rd} dimension parameters. In other words, rather than separately embedding depth values or other 3^{rd} dimension parameters that are translated to shifts in X-Y for left and right images at the receiver, the shifts for left and right images are computed prior to transmission and coded as deltas (pairs of changes for the left and right images) to the motion vectors. These deltas are then further coded (e.g., quantized, prioritized, etc. according to techniques discussed in this document) and steganographically embedded in the video signal.

Depth of color planes can be quantized even more coarsely (similar to JPEG chroma sub-sampling). In particular, bits are allocated more to 3^{rd} dimension parameters, such as depth, for higher priority color planes. In other words, greater depth detail is coded for higher priority color planes. Priority is determined based on factors such as visual importance in the video scene.

The use of steganographic encoding of 3D information in legacy video formats is a value-add (limit motivation for attack, malicious or otherwise) for all in the value chain:
Since robustness to attack (malicious by hackers or non-malicious through distortions of the content during distribution) is less of a concern for this application, more of the steganographic channel capacity can be dedicated to 3^{rd} dimension parameters as opposed to other information used to improve robustness, such as redundant encoding, error correction, synchronization signals, etc.
Compression rates are low and volume of content is large for legacy video formats, which increases the size of the steganographic channel within the primary legacy 2D video signal.
Transcoding does occur for some distribution paths, but more and more, the elemental bitstream of the primary video signal is retained, which enables the use of higher capacity embedding like the quantization method described above.
The transmission of multiple HD video streams over cable, wireless and other bandwidth-constrained channels requires the insertion of rate shapers and other modules that remove signal content to stay within bandwidth constraints. Further, the owners of the transmission channel are under no particular obligation to maintain out of band auxiliary information, such as the out of band information that is commonly suggested to convey 3D video information. As such, the use of a steganographic channel provides a means to convey 3D video information that is more likely to withstand effects of rate shaping and other signal manipulation where portions of the data signal are dropped.

There are several coding optimizations for the 3^{rd} dimension parameters.

### Depth Field:

If depth is overlaid over the frame independent of the content, it can benefit from annealing and interpolation techniques to contend with errors in depth from one cell to another (drop-outs, etc.)
Hierarchical encoding techniques (similar to wavelet decomposition) can be leveraged to code multiple levels of depth information in a multi-resolution format, etc.

### Object Tracking:

The right eye & left eye images are highly correlated. This means that large groupings of pixels can undergo common shifts, and thus be coded efficiently with a single shift value.
For an object, once an origin is identified, the shift can be applied and interpolated across the pixels. This means that the shift values can be coded once for each video object of interest and conveyed in the steganographic channel.
Hierarchies of objects and their relationships (position in 3D space, importance to the narrative, etc.) can be used to ensure Quality of Service (QOS). This hierarchy can be encoded in the steganographic channel.

While the above example discussed I frames specifically, Interpolated frames (e.g., P and B frames) have steganographic encoding capacity, though less so than 1 frames. The quantization approach has been shown for non-interpolated frames (DCT I Frames, in MPEG2 or wavelet frames, e.g., JPEG 2000 and Digital Cinema) but for interpolated frames (P,B), performance can suffer, if the 3D information corresponding to these frame is not efficiently coded.

One option to contend with this, motion vector and drift compensation, can be utilized as described in U.S. Patent Publication 2004-0125952, which is incorporated by reference in its entirety.

Another option is to carry the required information to adjust the subsequent motion vectors in the I frames.

High capacity, reversible watermarking techniques may also be used to embed 3D video information into a 2D video signal steganographically. Schemes for this type of steganographic coding/decoding are described in U.S. Pat. No. 7,006,662, which is hereby incorporated by reference in its entirety.

The above approach for carrying depth information can be implemented by carrying this depth information imperceptibly in a high capacity digital watermark within a single frame, for example the Left Eye only image, and then constructing the Right Eye image at the receiver addresses the issues raised above.

The differential between the right and left image is generally so minor, that the experience for viewers with 2D displays will typically not be affected and they can still enjoy the content utilizing legacy STB's, DVR's, displays, etc.

For the 3D aficionado, content is delivered utilizing the same protocols and devices from their existing carrier, e.g., the cable TV operator. However their display would decode the watermark, re-create the Right Eye image, and then display accordingly for the device at hand.

Beyond the before mentioned benefits, such techniques offer opportunities for customization by the consumer. Similar to the ability to tune the “staging” of the soundtrack of a movie with settings such as “studio” or “hall” etc. in a surround sound receiver, the same could be accomplished for the depth of the video. End users would be afforded the opportunity to scale the depth of the video for their viewing environment, an important factor in enhancing the experience. They could opt for a shallow “stage” or exaggerate the depth to their liking.

As noted above, there are a variety of means to generate the 3^{rd} dimension parameters for a video sequence. Depth information can be provided to the steganographic encoding method as a separate data-set (similar to topography information in geo-spatial applications.) Depth can be derived using computer vision techniques (Stereo Matching and Correspondence methods implemented in programmed computers).

### Particular Arrangements

According to one aspect, the present technology involves a system including a receiving device coupled to a source of video data, a display system for presenting rendered video data to a viewer, and a decoder for extracting steganographically encoded 3^{rd} dimension parameters from the video data. The system further includes a control for varying application of extracted 3^{rd} dimension parameters to rendering of the video data by the display system. By such arrangement, the system is able to render the same video data to yield different degrees of 3D effect, based on the control. In one particular arrangement the control is viewer-settable, enabling the viewer to vary the apparent depth of the 3D experience in accordance with the viewer's preference.

According to a related aspect, the present technology involves a method in which a steganographic encoding apparatus is used to steganographically encode 3^{rd} dimension parameter data into video data. This encoded video data is transmitted to first and second viewing systems. The encoded 3^{rd} parameter data does not define any one particular rendering experience, but rather enables the first viewing system to render the video with a first 3D effect, and enables the second viewing system to render the video with a second, different, 3D effect.

In accordance with a further aspect of the technology, image data corresponding to a view of a scene from a first location—such as from a left (right) eye perspective—is provided. A steganographic encoding apparatus (e.g., a hardware encoder, or a software-configured computer) steganographically encodes second data into the image data, which is then transmitted to a viewer premises for rendering of 3D imagery using a display device. (At least certain regions of imagery represented by the image data have second data corresponding thereto.) Rather than representing depth information, this second data comprises difference information.

In one particular arrangement, the difference information represents delta value information by which luminance and/or color values of pixels in the image data can be adjusted to yield pixels with values corresponding to a view of the scene from a second location—such as from a right (left) eye perspective.

In another particular such arrangement, the difference information represents vertical and horizontal spatial displacement data by which a view of the scene from a second location—such as from a right (left) eye perspective—can be generated from the image data.

A region of imagery having corresponding second data can be a square grouping of adjoining pixels. Or the region can comprise a video object (e.g., in the MPEG-4 sense—typically not having a square shape). Some regions may have no corresponding difference information.

Another arrangement involves steganographically encoding 3^{rd} dimension parameters into 2D image signals, e.g., for storage or transmission to a viewing system.

In one particular embodiment, these 3^{rd} dimension parameters are separated into levels along a depth axis, and coded at levels of detail that vary according to depth.

In another particular arrangement, these 3^{rd} dimension parameters comprise quantized values, and the quantization is scaled non-linearly. (For example, the quantization may represent depth, with different quantization intervals corresponding non-linearly to different depths. In one specific arrangement, successive quantization steps may correspond to logarithmically-scaled steps in depth.)

In some arrangements, different bandwidths of 3^{rd} dimension parameter data are allocated to different parts of the imagery. For example, one video object (e.g., in the MPEG-4 sense—typically non-square) may have M bits of 3^{rd} dimension parameter data associated therewith, while another may have N bits, where M>N. (Some parts may have none—allowing significant efficiencies in certain scenes.)

Similarly, the image signals may represent a frame of pixels comprised of non-overlapping tiled square regions (e.g., 8×8 pixel blocks). One of these regions may be steganographically encoded to convey N bits of 3^{rd} dimension parameter data, while another may be encoded to convey M bits. (Again, some may have none.)

In another example, one 2×2 patch of pixels may have three or less 3^{rd} dimension parameters associated with it—rather than one parameter per pixel (e.g., depth). In some cases, the entire square patch may be associated with just single 3^{rd} dimension parameter (e.g., spatial offset).

The bandwidth of 3^{rd} dimension parameter data allocated to different parts of the imagery can be based on priority of different image elements. The notion of visual priority is familiar, e.g., in certain video compression arrangements, in which elements of higher priority are encoded with more fidelity (e.g., less lossiness), and elements of lower priority are encoded with less fidelity (e.g., more lossiness). Thus, for example, a video object of higher priority can have a greater number of bits representing associated 3^{rd} dimension parameters than a video object of lesser priority.

One method assesses visual importance of different portions of imagery, and allocates different bandwidths for conveying 3^{rd} dimension parameters based on such assessment. Visual importance can be assessed based on regions of color to which the eye is relatively more or less sensitive. The former can be associated with more symbols (e.g., bits) of 3^{rd} dimension parameter data than the former. Similarly, higher visual importance can be based on detection of visually conspicuous edge features in a region of imagery rather than flat regions. Again, the former can be associated with relatively more 3^{rd} dimension parameter data.

In accordance with yet another aspect of the present technology, the image signals represent motion vectors associated with different portions of imagery, and at least certain of the motion vectors can be steganographically encoded to convey 3^{rd} dimension parameter data, such as left- and/or right-eye displacement data.

From the foregoing it will be recognized that embodiments of the present technology can be tailored to serve a variety of purposes and provide a variety of benefits. Many are characterized by providing 3D features while supporting legacy 2D viewing, and by providing significant coding efficiencies.

### Concluding Remarks

Having described and illustrated the principles of the technology with reference to specific implementations, it will be recognized that the technology can be implemented in many other, different, forms.

For example, while particularly described in the context of 3D video, it will be recognized that the same principles find application in related areas. One is 3D mapping, e.g., in which digital elevation data is associated with 2D map data to provide topographic information. Another is in 3D modeling and representation, such as is employed in medical radiography and other applications.

Also, while the disclosure has focused on steganographic encoding of 3^{rd} dimension parameters, many of the noted improvements can likewise be employed in applications that convey the 3^{rd} dimension parameters otherwise, such as by out-of band metadata, or other auxiliary data channels.

To provide a comprehensive disclosure without unduly lengthening the specification, applicant incorporates by reference the documents, including patents and patent applications, referenced above. (Such documents are incorporated in their entireties, even if cited above in connection with specific of their teachings.) Such references disclose technologies and teachings that can be incorporated into the arrangements detailed herein, and into which the technologies and teachings detailed herein can be incorporated.

The methods, processes, and systems described above may be implemented in hardware, software or a combination of hardware and software. For example, the auxiliary data encoding and decoding processes, such as steganographic encoding and decoding methods, may be implemented using a variety of apparatuses, including modules of program instructions executed on a programmable computer or converted into digital logic circuit modules of a special purpose digital circuit and/or programmable gate arrays. Computers include programmable processors, such as devices with microprocessors, Digital Signal Processors (DSPs), etc. Similarly, additional methods, such as signal processing methods, compression and data coding techniques, stereo correspondence and matching, video rendering, etc. described above may be implemented in software, firmware, hardware, or combinations of software, firmware and hardware, in programmable computers, devices and special purpose circuit modules. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

I claim:

1. A system comprising:
a receiving device coupled to a source of video data;
a display system for presenting rendered video data to a viewer;
a decoder for extracting steganographically encoded 3rd dimension parameters from the video data; and
a control for varying application of extracted 3rd dimension parameters to rendering of the video data by the display system;
wherein the system is able to render the same video data to yield different degrees of 3D effect, based on said control.

2. The system of claim 1 wherein the control is viewer-settable, the control enabling the viewer to vary the apparent depth of the 3D experience in accordance with a viewer preference.

3. A method comprising;
providing video data;
generating 3rd dimension parameter data associated with the video data;
using a steganographic encoding apparatus to steganographically encode the 3rd parameter data in the video data; and
transmitting the video data, with the 3rd parameter data steganographically encoded therein, to first and second viewing systems;
wherein the 3rd parameter data does not define any one particular rendering experience, but rather enables the first viewing system to render the video with a first 3D effect, and enables the second viewing system to render the video with a second, different, 3D effect.

4. A method comprising the acts:
providing image data corresponding to a view of a scene from a first location—such as from a left eye perspective;
using a steganographic encoding apparatus to steganographically encode second data into the image data; and
transmitting the image data, with the second data steganographically encoded therein, to a viewer premises for rendering of 3D imagery using a display device;
wherein a region of imagery represented by the image data has second data corresponding thereto, said corresponding second data comprising difference information—rather than depth information.

5. The method of claim 4 wherein the difference information represents vertical and horizontal spatial displacement data by which a view of the scene from a second location—such as from a right eye perspective—can be generated from said image data

6. The method of claim 4 in which said region comprises a square grouping of adjoining pixels.

7. The method of claim 4 in which said region comprises a video object, said video object not having a square shape.

8. The method of claim 4 wherein the difference information comprises delta value information by which luminance and/or color values of pixels in said image data can be adjusted to yield pixels with values corresponding to view of the scene from a second location—such as from a right eye perspective.

9. A method comprising the acts:
coding 3rd dimension parameters into a format; and
using a steganographic encoding apparatus to steganographically encode the 3rd dimension parameters into corresponding 2D image signals.

10. The method of claim 9 wherein the 3rd dimension parameters are separated into levels along a depth axis, and coded at levels of detail that vary according to depth.

11. The method of claim 9 wherein the 3rd dimension parameters comprise quantized values, where the quantization is scaled non-linearly.

12. The method of claim 9 wherein the 3rd dimension parameters comprise quantized values, where the quantization is scaled non-linearly along a depth axis.

13. The method of claim 9 wherein the 3rd dimension parameters are coded for video objects according to priority of video objects, with a video object of higher priority having a greater number of bits associated therewith to represent 3rd dimension parameters than a video object of lesser priority.

14. The method of claim 9 in which the image signals represent a frame of pixels comprised of plural non-overlapping tiled square regions, wherein a first of said regions is steganographically encoded to convey N bits of 3rd dimension parameter data, and a second of said regions, having the same size as the first, is steganographically encoded to convey M bits of 3rd dimension parameter data, where M>N.

15. The method of claim 9 in which the image signals represent a scene using an object-based representation in which each of plural non-square objects is separately coded, wherein a first object is steganographically encoded to convey N bits of 3rd dimension parameter data, and a second object is steganographically encoded to convey M bits of 3rd dimension parameter data, where M>N.

16. The method of claim 9 in which the image signals represent a frame of pixels including plural adjoining square 2×2 portions, wherein each such portion—comprising four pixels—is associated with less than four of said 3rd dimension parameters.

17. The method of claim 16 wherein each such portion is associated with only a single 3rd dimension parameter.

18. The method of claim 9 in which the image signals represent motion vectors associated with portions of imagery, wherein at least certain of the motion vectors are steganographically encoded to convey left- and/or right-eye displacement data.

19. The method of claim 9 that includes assessing visual importance of different portions of imagery, and allocating different bandwidths for conveying 3rd dimension parameters corresponding to said different portions accordingly.

20. The method of claim 19 in which the assessing comprises detecting a region of color to which the eye is relatively more sensitive, and assigning such region a higher visual importance.

21. The method of claim 19 in which the assessing comprises detecting a visually conspicuous edge region in the imagery, and assigning such region a higher visual importance.

22. The method of claim 9 in which the image signals represent several portions of spatial imagery, wherein a first portion has 3rd dimension parameters corresponding thereto, and a second portion has no 3rd dimension parameters corresponding thereto.

23. A physical medium conveying software instructions that configure a programmable computer to perform the acts of claim 9.
